(19) United States
(12) Patent Application Publication
(10) Pub. No.: US 2021/0114805 A1
(43) Pub. Date: Apr. 22, 2021

(54) INSERT FOR TRASH COLLECTION BUCKET

(71) Applicant: John O. Rorer, III, Philadelphia, PA (US)

(72) Inventor: John O. Rorer, III, Philadelphia, PA (US)

(21) Appl. No.: 16/658,550

(22) Filed: Oct. 21, 2019

(51) Int. Cl. B65F 1/08

(52) U.S. Cl. CPC B65F 1/08

(57) ABSTRACT

A frusto-conical insert composed of hinged, trapezoidal panels and having an upper opening, and a lower opening smaller than the upper opening, is insertible into a collection bucket for facilitating the removal of articles of trash from a trash picking spear and causing them to drop into the bucket. A set of notches is formed in the frusto-conical element at the location of the lower opening for receiving the spike of a trash picking tool. The insert has supports that extend downward from the location of the upper opening and engage the outer wall of the bucket. Hooks on the lower ends of the supports are positioned to engage a ridge on the exterior of the bucket to prevent the insert from being pulled out of the bucket in the process of disengaging trash from the picking spear. The insert is collapsible, and can be made from two identical molded parts.

### FIELD OF THE INVENTION

This invention relates to trash collection and more specifically to a device for facilitating the removal of items of roadside debris from a trash picking spear.

### BACKGROUND OF THE INVENTION

It is common for items of trash such as papers, cardboard food-containers, plastic bottles, metal cans and other items to be discarded alongside highways. This highway littering is a major problem for governments, and it has not been satisfactorily addressed by law enforcement efforts. As discarded items accumulate, crews of municipal workers, independent contractors, inmates from correctional institutions, and others, equipped with trash picking devices, walk along the borders of the highway and collect the discarded items for disposal.

Typically, each such worker utilizes a trash picking spear, i.e., an elongated, hand-held, stick with a stainless steel spike protruding from one end thereof to stab the discarded items, and move them to a collection container, which can be a bag with a shoulder strap carried by the worker or a bucket with a handle.

Transfer of the stabbed debris from the picking spear to the collection container can be carried out manually, using gloves. In other cases, the picking spear can be equipped with a stripping plate, movable along the spike, for detaching the items from the spike and dropping them into the container.

When gloves are used to remove trash from the picking spear, they must be cleaned frequently. On the other hand, picking spears equipped with stripping plates are more expensive than simple picking tools.

### SUMMARY OF THE INVENTION

An object of this invention is to provide a device for rapid and efficient removal of collected debris from a simple picking spear. Briefly, the invention is a device for insertion into a collection bucket that is utilized to remove articles of trash from the spike of a trash picking spear so that the articles drop into the bucket. A bucket has an advantage over a flexible collection bag having a shoulder strap, in that it does not need to be carried continuously by the worker. In areas where there are high concentrations of trash, the worker can place the bucket, with the insert installed, on the ground and collect a large number of articles without moving the bucket.

The bucket insert in accordance with the invention comprises a frusto-conical element having an upper opening and a lower opening smaller than the upper opening. A set of notches is formed in the frusto-conical element at the location of the lower opening for receiving the spike of a trash picking tool. In use, an item of debris impaled on the spike can be removed from the spike and dropped into the collection bucket by inserting the spike with the item of debris downward through said lower opening, moving a portion of the spike located above the item of debris laterally into one of the, notches, and pulling upward on the picking tool.

The term “frusto-conical” as used herein to describe the insert, refers to a shape that surrounds a longitudinal axis, preferably in substantially continuous closed path, and is tapered in the direction of the longitudinal axis so that one end is smaller than the opposite end.

Thus, in the bucket insert of the invention, the frusto-conical element is composed of a plurality of substantially trapezoidal flat panels, hinged to one another so that the frusto-conical element can be collapsed to a flattened condition, composed of two adjacent layers, such that its thickness is approximately twice the thickness of one of the panels.

The hinges by which the plurality of substantially trapezoidal flat panels are connected to one another are preferably in the form of narrow flexible hinges consisting of the same material from which the panels are formed. In this case, the hinges can be formed in the process of molding the components of the insert.

The bucket insert in accordance with the invention can be made by joining two identical molded components.

Plural supports are preferably utilized for attachment of the insert to a bucket. These supports may be connected to the frusto-conical element adjacent the location of its upper opening and extend downward from the upper opening on the exterior of the frusto-conical element. The supports preferably have lower ends with hooks. The hooks extend inward toward the frusto-conical element, for engagement with a ridge formed on the exterior of a collection bucket into which the frusto-conical element can be inserted. The engagement of the hooks with the ridge on the bucket prevents the insert from being pulled out of the bucket when a worker pulls upward on a picking tool to cause an item of debris to be separated from the spike of the picking tool and drop into the collection bucket.

In a preferred embodiment of the invention, the supports are not only flexible but resilient, and so that, when the supports are in a relaxed condition, the hooks at their lower ends are located within an imaginary cylindrical axial projection of the upper opening, whereby the hooks are able to remain in engagement with a wall of a collection bucket, and at a location underneath the ridge on the exterior of the bucket.

When the frusto-conical element is composed of a plurality of substantially trapezoidal panels, two supports can be utilized and can be arranged in opposed relationship to each other on opposite sides of the frusto-conical element. The frusto-conical element and the two supports can then consist of two identical molded parts joined together along a line extending through a median of each of the supports, and through a median of each of two of the substantially trapezoidal panels located in opposed relationship to each other. With this configuration, each of the two identical molded parts can be molded as a unit.

### BRIEF DESCRIPTION OF THE DRAWINGS

FIG. 1 is a top plan view of a preferred embodiment of the insert according to the invention, showing, in broken lines, a collection bucket into which the insert is fitted;

FIG. 2 is a vertical cross-sectional view of the insert, showing one of two opposite supports in a relaxed condition, and illustrating how the other support engages the outer wall of a collection bucket;

FIG. 3 is a plan view of one of the two identical molded parts that are joined together to form the insert;

FIG. 4 is a fragmentary plan view showing how the two identical molded parts are joined together;

FIG. 5 is an elevational view showing the insert in a collapsed condition; and

FIG. 6 is an oblique perspective view illustrating the use of the insert to remove an article of trash from a picking tool and thereby cause it to be dropped into a collection bucket.

### DETAILED DESCRIPTION OF THE PREFERRED EMBODIMENTS

The shape of the bucket insert is defined herein as “frusto-conical.” However, unless otherwise qualified, the term “frusto-conical” is intended to be interpreted in its broadest sense, to define a tapered, three-dimensional shape. It is not intended to imply that the cross-sections of the insert transverse to an axis are circular. In addition, the cross sections of the bucket insert in planes transverse to the axis can be circular, but are preferably polygonal. As shown in the drawings, the frusto-conical shape preferably consists of a plurality of planar, trapezoidal panels joined to one another in such a way that the insert can be collapsed for convenient storage and shipment. The cross-sections in planes transverse to the axis need not be continuous. Moreover, the polygonal cross-sections in planes transverse to the axis need not be symmetrical in relation to an axis, and the cross-sections in planes in which the axis lies need not be defined by straight lines. That is the axial sections, while preferably defined by straight lines, can be defined by curved lines.

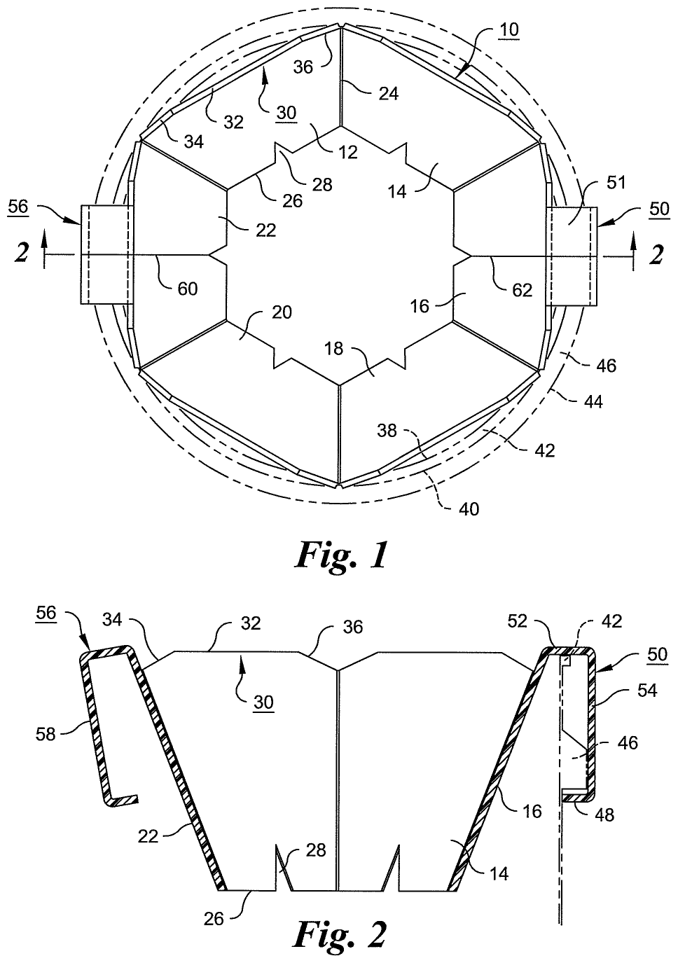

As shown in FIG. 1, a preferred embodiment of the bucket insert 10 comprises six, generally flat, trapezoidal, panels 12, 14, 16, 18, 20, and 22, arranged with the legs of each panel hinged to legs of adjacent panels along hinges, e.g., hinge 24, which joins panels 12 and 14. Each of the panels is preferably sufficiently thick that it is substantially rigid. As will be explained below, the insert can be formed by molding two identical parts. The hinges can be narrow, elongated, areas of the insert material, that are thinner and more flexible than the other parts of the insert and formed in the process of molding the insert. As shown in FIG. 1, the narrow, elongated areas that form the hinges are continuous with the inner walls of the trapezoidal panels, and thereby allow the panels to be bent in directions such that the insert has a frusto-conical configuration.

The shorter bases, e.g., base 26 of panel 12, form a polygonal lower opening, which is generally hexagonal in the case of six panels. Each of the shorter bases is formed with a V-shaped notch, e.g., notch 28 in base 26.

The longer bases, e.g., base 30 of panel 12, form a polygonal upper opening, also hexagonal in the case where the insert is composed of six panels.

In the embodiment shown in FIGS. 1 and 2, the longer base of each panel is composed of an elongated central edge portion 32 and two oblique edge portions 34 and 36 at opposite ends of the elongated central edge portion 32.

The circular broken lines in FIG. 1 represent a bucket into which the bucket insert 10 is placed. Broken line 38 represents the upper edge of the inner wall of the bucket. Broken line 40 represents the outer edge of a rim 42 on the upper edge of the perimeter of the bucket, the rim 42 also being shown in FIG. 2. Circular line 44 represents the outer perimeter of a ridge 46 formed on the outer wall of the bucket at a location below the rim 42 and extending in a circle around the perimeter of the bucket. As shown in FIG. 2, the lower side of ridge 46 is engageable by an inwardly extending hook 48 at the lower end of a support 50, which is connected to the upper edge of trapezoidal panel 16. The support 50 comprises a first part 52, connected to, and extending outward from, the upper edge of panel 16, a second part 54, which extends downward from the outer end of part 52, and hook 48, which extends inward toward the bucket from the lower end of part 54.

A similar support 56 is connected to the upper edge of panel 22 on the opposite side of the insert. The supports are resilient so that they can be bent outward to clear the ridge 46 for installation and removal of the insert. The resilience of the supports is such that, unless an external force is applied to the supports, they are urged into a relaxed position as illustrated by the position of support 56 in FIG. 1, in which the lower end of the second part 58 is positioned inward, relative to the upper end, toward the central axis of the insert. The configuration of the supports when relaxed ensures that the supports remain underneath the ridge 46 when the combination of the bucket and the insert is in use, and that the insert remains in the bucket when an upward force is exerted on the insert in the process of removal of an article of debris from the spike of a trash picking tool inserted though the lower opening and into one of the V-shaped notches, e.g., notch 28 in panel 12.

As seen in FIG. 1, the insert is composed of two identical parts that meet each other at a median line having two components, 60 and 62, which are aligned with each other on opposite sides of the insert. The median line extends through panels 16 and 22 and through the supports 50 and 56. The identical parts of the insert are preferably composed of a synthetic resin such as poly (vinyl chloride) (PVC), polycarbonate resin, poly (methyl methacrylate) and any of many other plastics. The parts can be secured to each other by fusion, adhesive, or by other suitable means such as reinforcing brackets and fasteners or reinforcing brackets fastened to the panel parts by adhesive.

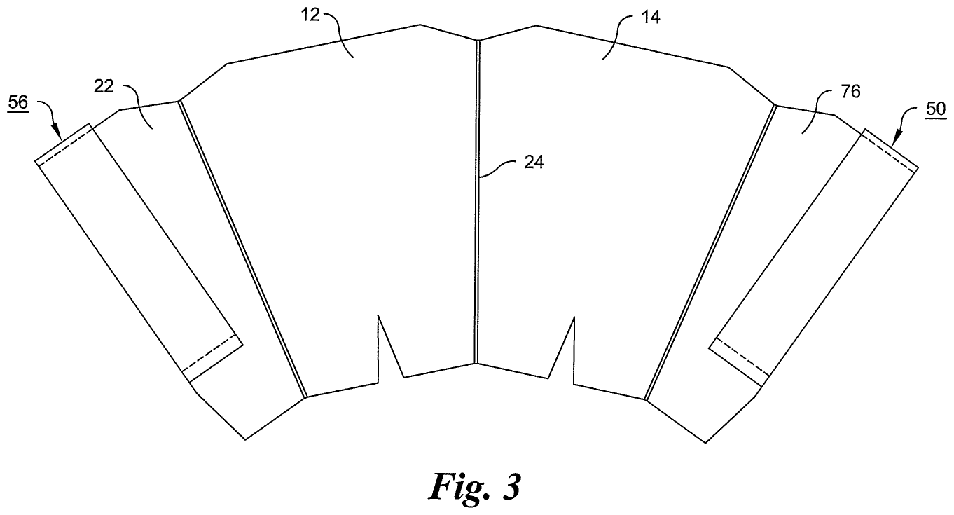

The two identical parts preferably come out the mold in which they are formed in a flat condition and are secured together after being bent to the frusto-conical configuration shown in FIG. 1. FIG. 3 shows one of the two identical molded parts in its flattened condition. The part shown in FIG. 3 comprises panels 12 and 14, one half of panel 22, one half of panel 16, one half of support 50 and one half of support 56.

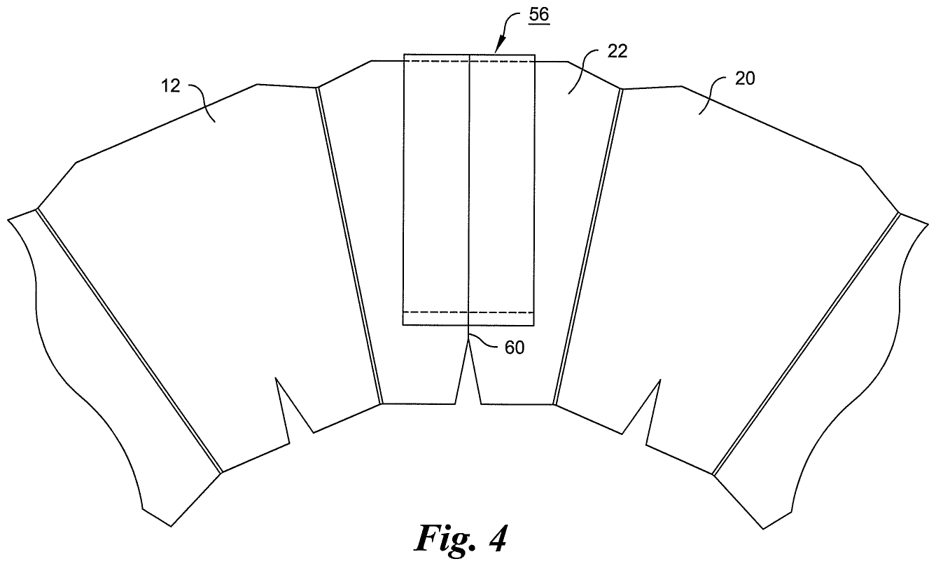

As shown in FIG. 4, in the assembly of the insert, the two identical molded parts are brought together along a median line 60 which extends through panel 22 and continues through support 56. The two parts can be fused together at the location of line 60 by the application of heat, or alternatively adhered together at the location of line 60 by the use of a suitable adhesive such as a cyanoacrylate glue, with or without a connecting bracket overlying the joined parts of the panel 22 and the support 56. The two parts of panel 16, and the two parts of support 50 can then be brought together by bending the set of panels into its frusto-conical configuration and fusing, or applying adhesive to, the meeting parts.

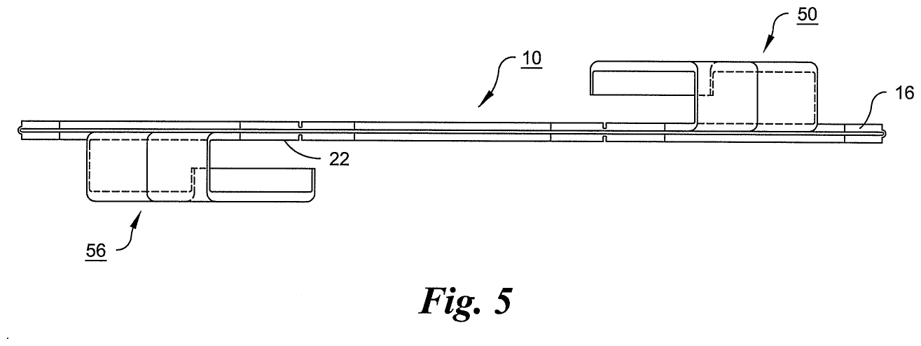

For storage or shipment, the insert 10 can be folded into a flattened condition having two adjacent layers, as illustrated in FIG. 5, and plural flattened inserts can be stacked on one another.

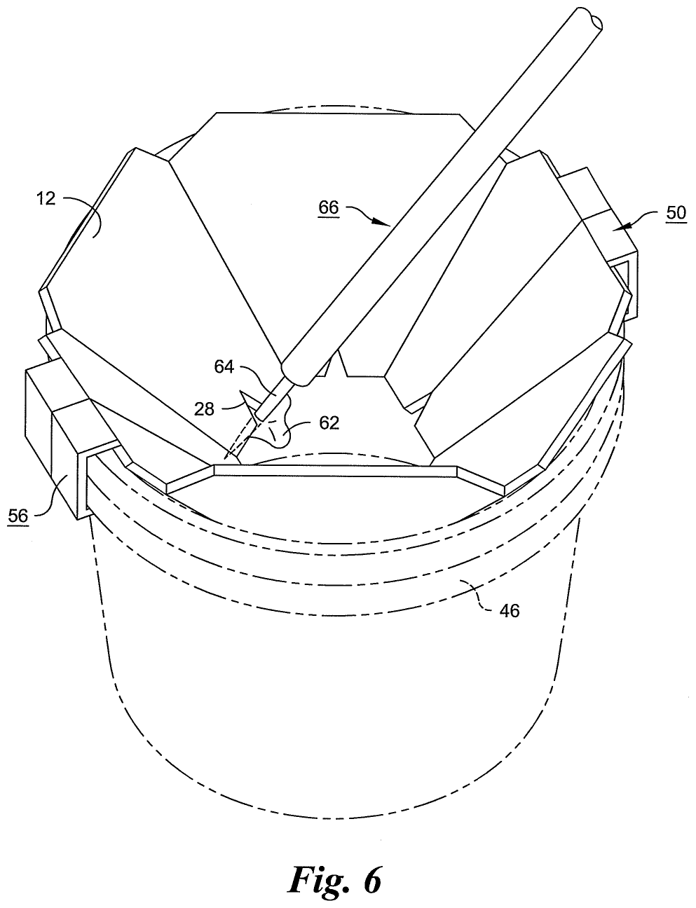

As shown in FIG. 6, an article of debris 62 impaled on the spike 64 of a picking tool 66 is passed downward through the insert and brought to a position underneath the perimeter of the lower opening of the insert, preferably by moving the spike into one of the V-shaped notches, e.g., notch 28 of panel 12. Then, by pulling upward on the picking tool, the article 62 can be removed from the spike and dropped into the bucket. The engagement of the hooks at the lower ends of the supports with the ridge 46 on the bucket prevents the upward force exerted through the picking tool from lifting the insert out of the bucket.

An advantage of the frusto-conical insert is that it is readily installed in a bucket and is prevented by the hook-shaped supports from removal from the bucket during use, but can be readily removed from the bucket after use by bending the supports outward to disengage them from the ridge on the bucket.

When the insert is composed of hinged trapezoidal panels, it can be flattened and stored for later use. Additional advantages, are that the insert is simple and can be produced by molding identical parts and joining the parts together in pairs, and that it is firmly secured by the supports to the collection bucket when in use.

Various modifications can be made to the insert as described. For example, the number and shape of the panels of the insert can be modified, and the number and shape of the supports that prevent the insert from being pulled out of the bucket can also be modified. The size of the insert and the shape and size of the supports can be selected to accommodate various different sizes and shapes of collection buckets. Other modifications can be made without departing from the scope of the invention as defined by the following claims.

What is claimed is:

1. A bucket insert for use in removal of debris from a trash picking tool, the bucket insert comprising a frusto-conical element having an upper opening and a lower opening, the lower opening being smaller than the upper opening, and a set of notches formed in the frusto-conical element at the location of the lower opening for receiving the spike of a trash picking tool, whereby an item of debris impaled on the spike can be removed from the spike and dropped into the collection bucket by inserting the spike with the item of debris downward through said lower opening, moving a portion of the spike located above the item of debris thereon laterally into one of said notches, and pulling upward on the picking tool.

2. The bucket insert according to claim 1, in which said frusto-conical element is composed of a plurality of substantially trapezoidal flat panels, hinged to one another whereby the frusto-conical element can be collapsed for storage or shipment.

3. The bucket insert according to claim 1, in which said frusto-conical element is composed of a plurality of substantially trapezoidal flat panels hinged to one another whereby the frusto-conical element can be collapsed into a configuration, consisting of two adjacent layers of said flat panels, for storage or shipment.

4. The bucket insert according to claim 1, in which said frusto-conical element is composed of a plurality of substantially trapezoidal flat panels hinged to one another by narrow flexible hinges consisting of the same material from which the panels are formed, whereby the frusto-conical element can be collapsed for storage or shipment.

5. A bucket insert for use in removal of debris from a trash picking tool, the bucket insert comprising a frusto-conical element having an upper opening and a lower opening, the lower opening being smaller than the upper opening, a plurality of supports connected to the frusto-conical element adjacent the location of the upper opening and extending downward from the upper opening on the exterior of the frusto-conical element, said supports having lower ends with hooks, extending inward toward the frusto-conical element, for engaging a ridge formed on the exterior of a collection bucket into which the frusto-conical element can be inserted, and a set of notches formed in the frusto-conical element at the location of the lower opening for receiving the spike of a trash picking tool, whereby an item of debris impaled on the spike can be removed from the spike and dropped into the collection bucket by inserting the spike with the item of debris downward through said lower opening, moving a portion of the spike located above the item of debris thereon laterally into one of said notches, and pulling upward on the picking tool.

6. The bucket insert according to claim 5, in which said supports are flexible and resilient and wherein, when said supports are in a relaxed condition, said hooks are located within an imaginary cylindrical axial projection of said upper opening, whereby said hooks are able to remain in engagement with a wall of a collection bucket into which the frusto-conical element is inserted.

7. The bucket insert according to claim 5, in which said frusto-conical element is composed of a plurality of substantially trapezoidal flat panels, hinged to one another whereby the frusto-conical element can be collapsed for storage or shipment.

8. The bucket insert according to claim 5, in which said frusto-conical element is composed of a plurality of substantially trapezoidal flat panels hinged to one another whereby the frusto-conical element can be collapsed into a configuration, consisting of two adjacent layers of said flat panels, for storage or shipment.

9. The bucket insert according to claim 5, in which said frusto-conical element is composed of a plurality of substantially trapezoidal flat panels hinged to one another by narrow flexible hinges consisting of the same material from which the panels are formed, whereby the frusto-conical element can be collapsed for storage or shipment.

10. The bucket insert according to claim 5, in which said frusto-conical element is composed of a plurality of substantially trapezoidal panels; in which said plurality of supports consists of two supports; in which said frusto-conical element and said two supports consist of two identical molded parts joined together along a line extending through a median of each of said supports and through a median of each of two of said substantially trapezoidal panels located in opposed relationship to each other; and in which each of said identical molded parts is molded as a unit.
